(19) United States
(12) Patent Application Publication
(10) Pub. No.: US 2008/0109549 A1
(43) Pub. Date: May 8, 2008

(54) Rental Server System

(76) Inventors: Kazushi Nakagawa, Kawasaki (JP); Takatoshi Kato, Kawasaki (JP); Takashi Tsunehiro, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/572,444

(22) PCT Filed: Jan. 27, 2005
(86) PCT No.: PCT/JP05/01056

§ 371 Date: Aug. 15, 2007

(30) Foreign Application Priority Data
Jul. 21, 2004 (JP) 2004-212463

(51) Int. Cl. G06F 1/00; G06F 15/00; G06F 17/00

(52) U.S. Cl. 709/225

(57) ABSTRACT

The service provider stores a program to use a service and license information in a memory card including an IC card chip, a flash memory, and an interface controller. According to the license information, the user can select a specification of a server PC on the service provider side and uses a server PC, which is maintained by the service provider, by use of the memory card through remote operation. Also, when the user reports the loss of the memory card to the service provider, a managing server on the service provider side sends a card function inactivation command to the memory card to prevent its false use.

### INCORPORATION BY REFERENCE

This application claims priority from Japanese Patent Application JP2004-212463 filed on Jul. 21, 2004, the content of which is hereby incorporated by reference.

### TECHNICAL FIELD

The present invention relates to a service system to lease a Personal Computer (PC) or the like via a network in a pay-by-the-hour charge system.

### BACKGROUND ART

With the recent development of PC use for general jobs in enterprises or firms, PCs come to operate with higher performance. As the performance becomes higher, the PCs to be lent to employees of firms are more frequently replaced by purchasing new PCs, and hence a large investment is required. Also, due to increase in the number of employees, it is quite difficult to manage, in a unified way, update of versions, bug fix, measures against virus, backup, and the like of the Operating System (OS) and job applications for each PC.

As a method of reducing the management cost, there has been employed a system operation method called server-client method. In this method, primary programs and data are accumulated on the server side to reduce data accumulated on the client side, for example, the Thin Client side.

In the server-client method, the arithmetic processing and data accumulation are carried out on the server side, which hence reduces necessity and frequency to individually conduct, on the client side such as the thin client side, update of versions, bug fix, measures against virus, removal of virus, and the like of the Operating System (OS) and applications used for jobs, and hence the overall management cost can be lowered. Moreover, the replacement of the hardware is required to be appropriately conducted only on the server side, and hence the cost reduction can be achieved.

Furthermore, recently, an IC card (having the alias of a smart card) integrally including a processor called an IC chip has drawn attention as a key device having an electronic authentication function. The IC card is a card in which a Central Processing Unit (CPU) is integrally included primarily in its internal IC card module. As a memory of the IC card, an ROM, an EEPROM or the like is used.

The IC card itself has an arithmetic function and hence has a function to determine by itself, upon read/write command from a host, whether or not the access is conducted from a correct user. Also, it is difficult to forge the CPU itself, and hence it is difficult to tamper with information issued from a tamper-resistant IC card module (IC card chip) or to conduct unauthorized access to the inside of the IC card module. This makes it possible to construct a system having a high security level. Most IC cards can conduct such control as whether to appropriately output information from the IC card to a reader-writer or a host by verifying in the card a Personal Identification Number (PIN) inputted from the user with a PIN held in the card for example.

The IC card includes therein a rewritable memory such as an EEPROM or an RAM and can store applications and information of the user and a card issuer. It is possible that the IC card conducts an arithmetic operation or the like for information inputted from an external device using information (such as a private key) existing only in the pertinent card to output to the external device outside the card information known only by the card owner, information created only by the card owner, or the like to thereby enable authentication of the card owner or to output information to prevent repudiation.

Additionally, a flash memory card is a memory card integrally including a nonvolatile memory module, and it is possible to store information of the user in the memory card. Most flash memory cards are not resistive against tamper. For flash memory cards without tamper-resistance, it is highly probable that when the card is stolen or lost, the card is disassembled and the memory or the controller in the card is analyzed and the information held therein is leaked to a third party.

For this point, a flash memory card having a flash memory interface and an IC card function is disclosed in, for example, JP-A-2001-209773. It is suitable due to its storage capacity size to carry about the flash memory card having a flash memory interface and an IC card function, the card having stored user's stored documents, setting files, and the like constructed in a personal computer or a workstation.

### DISCLOSURE OF INVENTION

In the server-client method described above, to provide services to all employees, it is required for the firm to update the server and to conduct user registration management. Therefore, the information management division of the firm requires a large investment and a large number of people. Also, there exists a problem in appropriate distribution of the PC hardware resources according to the jobs of employees.

According to the present invention, a PC corresponding to a use purpose of the user is provided to the user by use of a memory card including an IC card function.

Features of the present invention will be clarified according to the description and the accompanying drawings of the specification.

According to the present invention, a service provider stores a program to use a service and license information in a memory card including an IC card chip, a flash memory, and an interface controller to thereby provide a system in which the user can select a specification of the server PC according to the license information and can use a server PC maintained by the service provider, by use of the memory card through a remote operation. In addition, there is provided a system in which when the user reports the loss of the memory card to the service provider, the managing server transmits a card function invalidation command to the memory card to prevent false use of the memory card.

According to the present invention, there is provided a rental PC service in which a memory card having stored license information is sold or distributed such that the user uses through a remote operation the server PC on the service provider side, enabling reduction in the total cost for property in the firm and reduction in the PC replacement cost for individual person.

The other objects, features, and advantages will be more apparent from the following description of the embodiments of the present invention in conjunction with the accompanying drawings.

### BEST MODE FOR CARRYING OUT THE INVENTION

Referring to drawings, description will now be given of embodiments of the present invention. Incidentally, the items assigned with the same reference numerals in the drawings indicate the constituent components having the same functions, and detailed description thereof will be avoided for convenience of the description.

### Embodiment 1

FIG. 1 is a diagram to explain a first embodiment of the present invention. A user terminal or a PC terminal 1000 which the user utilizes to access the service provider system includes a CPU 1010, a memory 1015, a network connector 1050, a mouse 1020, a key-in unit 1030, a display 1040, and a reader-writer 1060. The mouse 1020 and the key-in unit 1030 may be replaced by a device which propagates user input information from a touch panel, a joy stick, or the like to the user terminal 1000. The user terminal 1000 is connectible via the network connector 1050 to a network 1230. The network 1230 is, for example, the Internet, a WAN, a LAN, a telephone network, a CATV network, a satellite communication network, a wireless LAN, and the like. The network 1230 propagates input information 4020, screen information 4030, and the like. The display 1040 displays also an advertisement 4000 and information 4010 regarding a service use state. Additionally, the user terminal 1000 may be a cellular phone, a Personal Digital Assistant (PDA), or any device including constituent components similar to those of the cellular phone or the PDA. For example, a PDA 1005 includes as input units a stylus 1035, a display 1045 as a touch panel, and a reader-writer 1061 and differs in structure from the user terminal 1000, but has the same function as that of the user terminal 1000.

The reader-writer 1060 includes interfaces such as a Universal Serial Bus (USB) and a short-distance radio communication and is capable of connecting to the user terminal 1000 and also includes an interface capable of connecting to a memory card 1220, which will be described later. Furthermore, the reader-writer 1060 may include a fingerprint authentication unit and a PIN input pad, not shown.

The memory card 1220 includes an interface controller 1070, an IC card chip 1080 having tamper resistance, and a flash memory 1090 which is a nonvolatile storage. The interface controller 1070 includes a CPU 1100, a memory 1110, and a Read Only Memory (ROM) 1120 to store firmware and the like and conducts control of the overall memory card 1220 and executes interface processing. The IC card chip 1080 includes a CPU 1140, a memory 1150, an ROM 1160, a nonvolatile memory 1170, and a fuse 1175, and the ROM 1160 stores a license information processing program and a PIN verification program. The CPU 1140 and the memory 1150 are used to execute the license information processing program and the PIN verification program, and the nonvolatile memory 1170 stores license information and PIN information. The fuse 1175 is used to make an excess current flow to physically disconnect inner wiring. The flash memory 1090 stores a license authentication program 1180, a remote control program 1190, and the like.

The server PC system 1240 includes a gateway 1250, server PCs 1300 and 1305, and a storage 1330. The gateway 1250 includes a CPU 1260, a memory 1270, a disk unit 1280, and a network connector 1290 and is connected to the network 1230 and the server PCs 1300 and 1305. The disk unit 1280 stores an encrypting program 4040 and the like. The server PC 1300 includes a CPU 1310, a memory 1320, and the like. Although only two server PCs 1300 and 1305 are shown, the number thereof is not limited, and the specification may differ between the CPUs and the memories respectively of the server PCs.

The storage 1330 is connected to the server PCs 1300 and 1305 and stores an OS 1340, personal environmental data 1350, an application program 1360, and the like. The application program 1360 includes a spreadsheet application, a word processor application, and the like.

A managing server 1460 includes a CPU 1370, a memory 1380, a display 1390, a network connector 1400, and a disk 1450. The disk 1450 stores a user management program 1410, an advertisement distribution program 1420, a virus check program 1430, a backup program 1440, and the like. The managing server 1460 conducts operation such as control of the overall server PC system 1240.

Next, referring to FIG. 2, description will be given of a flow at start of the use of the rental PC service.

A user 2000 of the rental PC service activates the license authentication program 1180 stored in the memory card 1220 (2010). The license authentication program 1180 is loaded in the memory 1015 of the user terminal 1000 (2020) to be executed by the CPU 1010 and then transmits a license authentication request to the managing server 1460 (2030). The managing server 1460 having received the license authentication request sends an authentication information request to the user terminal 1000 (2040). The user terminal 1000 having received the authentication information request displays a PIN input dialog to urge the user 2000 to input a PIN (2050). The user 2000 inputs a PIN from the key-in unit 1030 or a PIN input pad, not shown (2060). The user terminal 1000 having received the PIN sends a verification request of the PIN to the memory card 1220 (2070). The memory card 1220 having received the verification request of the PIN conduct verification of the PIN by the IC card chip 1080 (2080). If the PIN verification is successfully finished, the IC card chip 1080 outputs authentication information, and the memory card 1220 sends the authentication information to the connected PC 1000 (2090). The user terminal 1000 sends the authentication information to the managing server 1460 (2100). The managing server 1460 verifies the authentication information (2110).

If the verification is successfully finished, the managing server 1460 notifies the verification success to the user terminal 1000 (2120). In the operation, the managing server 1460 also notifies specifications of the server PC system 1240 as an object of management (such as a specification of the CPU, the memory capacity, available application programs of the server PC). On the basis of the specifications of the server PC system 1240, the user terminal 1000 displays optional items for the selection of a target service to be used and urges the user 2000 to select a target service (2130). A user interface to urge the user service selection will be described later by referring to FIG. 3.

The user 2000 selects a target service (2140). The user terminal 1000 notifies the selected target service to the managing server 1460 (2150).

According to the selected information, the managing server 1460 assigns the server PC 1300 of the CPU specification and the memory capacity to the user, determines a storage capacity to store the personal environmental data 1350 and the like, determines availability or unavailability of a backup service, a virus check service, a word processor application, and a spreadsheet application as well as the type of the operating system which runs on the server PC 1300, and determines presence or absence of advertisement distribution.

In this connection, to assign the server PC 1300 to the user indicates in a case in which the CPU specifications of, for example, 500 MHz, 1 GHz, and 2 GHz are prepared for the server PC that for the user 2000 having selected 500 MHz as the CPU specification, a server PC of the CPU specification of 500 MHz or less is available; or indicates in a case in which only the CPU specification of 1 GHz exists for the server PC that a restriction command to restrict the 1 GHz CPU to operate on 500 MHz is sent to the server PC so that the server PC operates as a CPU of 500 MHz.

The backup service is a service in which the managing server 1460 backs up in a backup device (a tape device, a CD, a DVD, a hard disk, or the like) the data stored in the storage 1330 in a periodic fashion or when an update operation is conducted so that the data can be restored using the backup device at occurrence of a failure in the storage or in response to a restoration request from the user 2000.

The virus check service is a service in which the managing server 1460 detects, in the data in the storage 1330, data matching a virus pattern and removes the data.

To make the word processor application and the spreadsheet application available means that the application program 1360 stored in the storage 1300 is available for the server PC 1300 assigned to the user 2000.

To determine the type of the operating system indicates that the OS selected by the user from the OS 1340 stored in the storage 1330 is available for the server PC 1300 to which the OS is assigned.

To conduct advertisement distribution is that the managing server 1460 inserts the advertisement 4000 in the screen information 4030 to present the advertisement to the user 2000.

The managing server 1460 registers the target service of the user 2000 (2160). The managing server 1460 notifies an event of successful registration of the target service via the user terminal 1000 to the user 2000 (2170). However, the flow from the target service selection request 2130 to the registration success notification 2170 (2130, 2140, 2150, 2160, 2170) is required to be conducted only once, and may be skipped for the second and subsequence uses.

Next, the user 2000 activates the remote control program 1190 stored in the memory card 1220 (2180). The remote control program 1190 is loaded in the memory 1015 of the user terminal 1000 (2190) to be executed by the CPU 1010 and sends a use start request to the managing server 1460 (2200). The managing server 1460 confirms the registered target service information (2210), assigns the server PC 1300 according to the target service information, and makes the registered server PC available (2220). The assigned server PC 1300 loads from the storage 1330 the personal environment data 1350 corresponding to the user 2000 and the OS 1340 (2230). Also, it is possible that the personal environment data 1350 is stored in the storage 1330 in a method in which the user 2000 beforehand delivers a Compact Disc (CD) of the data to the service provider side or in a method in which the data is uploaded via a network.

As the method to upload the personal environment data 1350 via a network, there can be considered a method in which, for example, if a selection item of upload of the personal environment data 1350 is added as one of the target service and the user 2000 selects the upload, the personal environment data beforehand prepared in the user terminal 1000 of the user is uploaded in the storage 1330 so that the server PC 1300 can be used in a personal environment equal to that of the connected PC 1000. Incidentally, the personal environment information of the user is, for example, a document file, mail data, setting information belonging to the person and is stored in the storage with a relationship to the user identifier, and the correspondence relationship between the personal environment information and the user identifier is stored by the managing server (see FIG. 13). The user identifier may be a parameter which can identify the user, for example, the PIN described above.

The user 2000 uses the server PC 1300 by the remote control program (2240). When the use is finished, the user 2000 notifies the condition to the server PC 1300 (2250). The server PC 1300 saves the loaded personal environment in the storage 1330 (2260) and deletes data lest the personal environmental data 1350 and the like remain in the memory 1320 of the server PC 1300, and then notifies the normal termination to the user terminal 1000 (2270). In the method of deleting the data lest the personal environmental data 1350 remain therein, for example, the managing server 1460 writes random numbers in the memory 1320 of the server PC 1300 or clears the memory using zeros; or, for a nonvolatile memory, the managing server 1460 sets the voltage to 0 V to thereby clear the data. In this regard, the managing server 1460 reads data from the memory 1320 to confirm whether or not random numbers have been written therein or whether or not the memory has been cleared using zeros.

As above, it is possible for the service user to carry about the memory card 1220 containing the license authentication information and the programs (1180 and 1190) for the service use, and hence usability is improved for the user. Additionally, the license authentication information is stored in the IC card chip having tamper resistance to prevent copying and alteration of the information, and the programs (1180 and 1190) for uses with low requirement for concealment are stored in the flash memory less expensive than the IC card chip, leading to an advantage of implementing a low-cost service with high security.

Next, referring to FIG. 3, description will be given of a method for the user 2000 to select a target service (2140).

In FIG. 2, when the target service selection request is sent from the managing server to the user, a view example in which optional items, contents of selection, required points, and the like are displayed as shown in FIG. 3 is displayed in the connected PC. According to the view example, the user 2000 can select a specification and a target application for the server PC 1300 at target service selection.

It is assumed that the managing server beforehand stores, as the information for selection, the performance of the server PC to be connected to the managing server (see FIG. 12). When a new server PC is connected to the managing server, the PC server may notify its performance to the managing server using Universal Plug and Play (UPnP) or the manager or the like of the managing server may register the performance to the managing server. In this regard, the respective substrates of FIG. 12 correspond to the respective server PCs in the embodiment.

As can be seen from FIG. 3, the optional items for the user include the CPU specification of the server PC, the memory capacity thereof, the storage capacity, necessariness or unnecessariness of the personal environmental data backup service, necessariness or unnecessariness of the virus check service, necessariness or unnecessariness of the word processor application, necessariness or unnecessariness of the spreadsheet application, selection of the operating system, and approval or disapproval of the advertisement distribution.

For example, in the selection of the CPU specification of the server PC, the user may select a specification of available CPU performance from a pull-down menu or may input a particular numeric value for designation. In a case in which a numeric value is inputted, the managing server 1460 sends, for the operation according to the specified CPU specification, a command to restrict the clock frequency of the CPU 1310 of the server PC 1300.

The memory card 1220 possessed by the user 2000 has stored unique license authentication information, and point balance information is registered to the managing server 1460 and the memory card 1220 according to the license authentication information. The service provider beforehand registers the point balance information according to the price of the memory card before the memory card is sold. At an interval of a fixed period of time determined by the service provider in advance, required points are subtracted from the point balance.

Also, the point balance information at each use of the server PC by the user may be notified during the license authentication process from the memory card 1220 via the user terminal to the managing server. The required points for the user of a fixed period of time vary depending on the items selected by the user 2000. The fixed period of time is a predetermined period of time, for example, one week or one month. If a specification of a high function is selected or if use of an application is selected, the required points are greater; and if the advertisement distribution is approved, the required points take a negative value.

Incidentally, the managing server compares the point balance of the user notified from the user with the total points required for the service sent from the user and provides the service desired by the user if the point balance of the user is more than the total points required for the service.

If the total required points exceed the point balance, the condition is displayed to the user to urge the user to change the selection of the target service; the service cannot be used until the user conducts selection within the point balance. Also, it is possible that the managing server retrieves combinations of target services within the point balance to present the combinations to the user. For example, the total required points are 800 points in FIG. 3; if the point balance is 700, the managing server issues a notification and/or conducts control, for example, to make the spreadsheet application unusable.

Referring to FIG. 14, description will be given of the providing of services and the points.

The point balance information of the user is stored in the memory card or the managing server or in both thereof, and the managing server reads the point information therefrom when the user conducts the target service selection (7000). The managing server transmits optional service items to the user terminal by referring to the read-out point information, a recommended combination of a CPU specification and a memory capacity for each OS and a recommended combination of an available application and an available service as exemplified in FIG. 12 (available substrates) and FIG. 15, and a required point table for each selection item as exemplified in FIG. 16 (7010). At transmission of the service items, the recommended selection items may be presented, for example, if the CPU specification of 1 GHz is selected, the memory capacity of 512 Megabytes are favorably selected. Also, a combination of unavailable selection items may be presented, for example, if OS1 is selected as the OS, the spreadsheet application cannot be selected.

The user selects service items and sends the selected result to the managing server (7020). According to the selected result and the point balance information, the managing server verifies whether or not the points are insufficient (7030). If the points are insufficient, the managing server urges the user to again conduct the selection. If the points are sufficient, the managing server starts providing services (7040). During the providing of services, the managing server subtracts the required points from the point balance at an interval of a fixed period of time (7050). If a report of the loss of a memory card is received from the user during the providing of services (7060), the reception of the loss is registered to the managing server; the managing server then copies the license information and the like onto a new memory card to reissue the card to continue the providing of services (7100). If a report of cancellation is received from the user during the providing of services, the reception of the cancellation is registered to the managing server, and the amount of money equivalent to the point balance is reimbursed to the user; the managing server invalidates the license information of the pertinent memory card and stops the providing of services thereafter (7110). If a report of a change of selected items is received during the providing of services (7080), the managing server accepts the reselection of services. If the managing server detects the insufficiency of the point balance during the providing of services (7090), the managing server stops services (7120) and keeps the services stopped until the user additionally deposits an amount of money (7130) and the point balance is sufficient.

As above, the user can select a server PC specification and a target application according to his or her requirement; moreover, by displaying the points required for the use of a fixed period of time and the point balance, the user can instinctively conduct the selection, which improves the service quality.

Next, by referring to FIG. 4, description will be given of an example of registration data managed by the managing server 1460.

The memory card 1220 is assigned with a license number corresponding to the unique license authentication information. Although now shown, the license number may be associated with the user identifier shown in FIG. 13. As can be seen from FIG. 4, the managing server 1460 manages the license number and registers information of the target service for each license number. The target service information includes the service use start time, the use state (unregistered, in use, use ended, etc.), the CPU specification of the server PC 1300, the memory capacity thereof, the storage capacity, necessariness or unnecessariness of the backup service, necessariness or unnecessariness of the virus check service, necessariness or unnecessariness of the word processor application, necessariness or unnecessariness of the spreadsheet application, selection of the operating system, and approval or disapproval of the advertisement distribution. Moreover, the managing server manages log information including the price of the memory card 1220, the additional amount of money, the point balance, the date when the user 2000 reports the loss of the memory card 1220 to the service provider, unauthorized access log items (such as the date and an IP address) when the license authentication is conducted after the loss is reported, completion or incompletion of transmission of the card function inactivation command to make the memory card 1220 unusable when the unauthorized access is conducted, and the use date and the IP address. The card function inactivation command is a command to destroy the function of the memory card 1220 physically or softwarewise to invalidate the card. The command will be described later by referring to FIG. 6. Additionally, when the target service is changed, there is saves the log of the target service being selected up to this point of time. The subtraction of points from the point balance may be conducted for each lapse of the fixed period of time beginning at the service start or may be conducted according to an actual period of time of use of the server PC 1300. In the case in which the subtraction of points from the point balance is conducted for each lapse of the fixed period of time, if the service is changed before the lapse of the fixed period of time, the points to be subtracted are calculated according to a daily rate or the like.

As above, by registering the target service selected by the user to the managing server 1460, it is possible for the service provider to precisely manage the service contents for each memory card. In addition, by managing the memory card loss report date, the false access can be prevented; and by transmitting a card function inactivation command to make the memory card unusable, it is possible to prevent use of the lost memory card by a third party.

Next, description will be given in detail of use of the server PCs (1300 and 1305) by the remote control program 1190.

When the user attempts from a terminal such as the user terminal 1000 or the PDA 1005 to connect the terminal to the server PC (1300 and 1305), the managing server 1460 detects the connection from the user and then reads, according to the PIN information, the user identification or the like, the target service information, the license number, and the like associated therewith to conduct server PC assignment. Incidentally, the managing server includes a management table of server PCs prescribing optionality and usability as shown in FIG. 12 and controls server PCs for the assignment according to the table.

The managing server selects an assignable substrate by referring to, for example, the target service information sent from the user and the performance, the use state, and the like of a substrate corresponding to the target service information and then updates the associated locations such as a location 1206 of FIG. 12 and a location of 1302 of FIG. 13.

Next, the managing server 1460 refers to the personal information management table shown in FIG. 13 to load the personal environmental data 1350 and the OS 1340 in the assigned server PC.

In this connection, if there exists no available server PC at server PC assignment, the managing server notifies the condition to the user and then enters the wait state to stay therein until an available server PC is present. When the use termination is notified from the server PC, the managing server recognizes that the server PC as the transmission source of the notification is in an available state, and then updates FIGS. 12 and 13.

In the connection by the user terminal 1000, the input information 4020 inputted from the mouse 1020 and the key-in unit 1030 is transmitted by the remote control program 1190 via the network 1230 to the gateway 1250. The gateway 1250 inquires the address information 1206 of the server PC assigned to the user of the managing server 1460, and thereafter transmits the received input information 4020 to the server PC using the address information. The server PC 1300 executes processing according to the received input information, sends the resultant screen information 4030 to the gateway 1250; and the gateway 1250 sends the received screen information 4030 to the user terminal 1000. The user terminal 1000 displays the received screen information on the display 1040. The input information 4020 and the screen information 4030 may be encrypted between the user terminal 1000 and the gateway 1250. The key used for the encryption is shared between the user terminal 1000 and the gateway 1250 after the license authentication is successfully finished (2120).

In addition, the input information 4020 and the screen information 4030 may be compressed to reduce the data capacity thereof for transmission and reception. The screen information 4030 of the user having selected the approval of advertisement distribution includes the advertisement 4000. The screen information 4030 may also include the information 4010 regarding the service use state such as the use end date. The advertisement and the information regarding the service use state may be notified by e-mail or the like to the user. It is also possible that the server PC 1300 may acquire information regarding the display 1040 of the user terminal 1000 (for example, a refresh rate, screen resolution, a character font size, luminance, chroma, brightness, the type of the display such as a plasma display, a liquid-crystal display, and a (CRT display), and the display position of the screen information 4030), and may include a function to appropriately convert the screen information 4030 according to the information regarding the display 1040. For example, in the case of a device with a small display such as a cellular phone or a PDA, only partial important screen information is displayed to be clearly perceived, character information is enlarged for easy reading thereof, and the display positions of the advertisement 4000 and the information 4010 regarding the service use state are changed. Also, if the luminance of the display is low, it is possible to increase the luminance and the chroma of the transmitted image to convert the color information. Furthermore, the server PC 1300 may include a function to change the setting information regarding the display 1040 of the user terminal 1000 (for example, the refresh rate, luminance, brightness, chroma, and the display position of the screen information 4030). This can be implemented through an operation in which the server PC 1300 transmits a command to change the setting information to the user terminal 1000 and the user terminal 1000 having received the command changes the setting information of the display 1040.

Moreover, the server PCs (1300 and 1305) installed as many as there are users may be replaced by one server so that a plurality of users share the server PC in the use thereof. This is the case of sharing one server PC and can be implemented through an operation in which the use environment is individually loaded for each user and the CPU and the memory resource are used in a time-sharing fashion.

According to the present invention described above, in the terminal service including the user terminals and the server PCs, it is possible to appropriately notify the advertisement and the information regarding the use state. Additionally, the usability is improved by appropriately converting the screen information 4030 according to the type of the user terminal.

Next, description will be given of the processing flow of the service provider by referring to FIG. 5.

Using the PC or the like for the service provider, the service provider beforehand writes license information and an initial PIN required to use the license information in the IC card chip 1080 of the memory card 1220 and writes the license authentication program 1180 and the remote control program 1190 in the flash memory (5000) and registers to the managing server 1460 a license number corresponding to the license information, the price, the point balance, and the like. The memory card 1220 is sold in a shop, for example, together with a sheet of paper on which the initial PIN is written so that the user uses the license information (5010). The server PC receives via the managing server the target service registration from the user (5020) and connects to the user PC to start providing services (5030). If the point balance is insufficient to receive the service(5040), additional money request confirmation information is sent to the user terminal of the user; and if the user desires the addition of money and the addition thereof is confirmed in a predetermined method, the service is continuously provided (5050). If the addition of money does not take place, an inquiry is sent to the user to confirm whether or not the personal environmental data delivery is necessary (5060). To the user who has replied the necessity of the data delivery, the data is delivered using a medium such as a CD or it is possible to download the data via a network (5070). In this situation, to prevent the personal environmental data from being acquired by any other person, the managing server delivers the personal environmental data or confirms the download thereof after the license authentication of the memory card 1220 is conducted using the user identifier or the like. When the managing server 1460 detects expiration of the save period of the personal environmental data (5075), the managing server 1460 deletes the personal environmental data (5080) and terminates the service (5090).

As above, it is possible to implement a rental PC service of prepaid type using a memory card purchasable in a shop. Moreover, at the end of the service, the personal environmental data created by the user during the service can be acquired in hand, which improves the usability.

Next, by referring to FIG. 6, description will be given in detail of the card function inactivation command for the lost memory card of which the loss has been reported.

When the memory card is lost, the user immediately reports the loss of the memory card to the server PC or the managing server. The server provider receives the report of the loss to recognize the memory card loss and then transmits the license number, the loss report date, and the like to the managing server 1460; and the managing server 1460 registers the license number to the table of FIG. 4; if an access is attempted using the license number thereafter, the managing server 1460 regards the access as unauthorized. At reception of the loss report, if the license authentication is conducted using the Public Key Infrastructure (PKI), the managing server 1460 registers it to the Certificate Revocation List (CRL). If an unauthorized user 6000 having attained the lost memory card activates via the user terminal the license authentication program (6020) to load the program in the user terminal (6030), the CPU of the user terminal executes the license authentication program and hence a license authentication request is sent to the managing server 1460 (6040). If the license number in the license authentication request matches the license number registered as that of the lost memory card 6010, the managing server 1460 sends the card function inactivation command to the user terminal connected to the memory card (6050).

The card function inactivation command includes the license number of the memory card and a PKI signature of the managing server. The user terminal 1000 having received the command transmits the command to the lost memory card 6010 (6060). When the card function inactivation command is received, the lost memory card 6010 confirms whether or not the license number of the command is equal to the own license number to thereby verify the PKI signature of the managing server. If the license numbers do not match each other or if the verification of the PKI signature ends in failure, the command is regarded as unauthorized and is hence discarded; if the PKI signature verification ends in success, the wiring in the IC chip card 1080 is physically disconnected by passing an excess current through the fuse 1175 thereof to invalidate the card function (6070), which makes the IC card chip 1080 unusable thereafter (6080). Referring to FIG. 11, description will be given in detail of the mechanism to pass the excess current. FIG. 11 shows an example of the mechanism to disconnect wiring between the CPU 1140 and the memory 1150 of the IC card chip 1080. Between the CPU 1140 and the memory 1150 of the IC card chip 1080, there are disposed an amplifier 1176, wiring 1177 to feed a control signal to the amplifier, and a fuse 1175 connected to an amplified output line of the amplifier. To invalidate the card function, the CPU 1140 sends a signal to the wiring 1177 and then the amplifier 1176 produces an amplified voltage to pass an excess current to the fuse 1175. The fuse 1175 generates heat due to the excess current and melts, which destroys the physical wiring.

Furthermore, the CPU 1140 may clear, using zeros, the license information and the concealed information stored in the nonvolatile memory 1170 or may erase them by overwriting random number; the interface controller 1070 may clear the program stored in the flash memory 1190 using zeros or may erase them by overwriting random number. The physical destruction by the fuse may be conducted in the interface controller 1070 and the flash memory 1090 or may be conducted in the wiring which connects the interface controller 1070, the flash memory 1090, and the IC card chip 1080 to each other. In addition, in the method of invalidating the card function, the IC card chip 1080 may be molten to be destroyed by heat of a heating wire or the chip 1080 may be molten to be destroyed by heat generated by burning an inflammable item; any method which physically destroys and makes the card unusable may be arbitrarily employed. Also, it is possible that a function inactivation flag is softwarewise set in the IC card chip 1080 such that no command is accepted thereafter.

As above, even when the user loses the memory card, the false use thereof can be prevented by invalidating the function of the memory card.

Next, by referring to FIG. 7, description will be given of processing between the service provider and the personal user up to the service use.

The memory card 1220 in which the license information is written in the IC card chip 1080 and the program is written in the flash memory 1090 by the service provider is delivered to the user (6500). When the license information is sent from the user via the user terminal to the managing server, the managing server registers the point balance, the license number, and the price corresponding to the license information to the table of FIG. 4. Also, the service provider maintains and manages the server PC system corresponding to the license information registered to the managing server (6530). When the personal user purchases the memory card (6510, 6515), the contents are registered to the managing server for each license. The personal user uses the server PC system using the license information in the purchased memory card 1220 (6520) and the server PC system provides a service according to the license information registered to the managing server (6525).

As above, the user may use the service while keeping the concealment. Additionally, in the form of a sale in which a contract is made, it is possible to use a complex service such as the automatic transfer service of the additional amount of money. The automatic transfer service of the additional amount of money or the like can be implement through an operation in which when the user receives a notification from the managing server that the point balance is insufficient, the user notifies the depositing of the additional money to the managing server, and the managing server transfers the amount from a bank account of the user by use of the data registered when the contract is made. To prevent unauthorized deposition of an amount of money by an unauthorized person, the license authentication is conducted using the memory card before the notification of the additional depositing of money to the managing server.

Furthermore, in accordance with the present invention, the user terminal 1000 and the server PC 1300 may be, in addition to PCs, cellular phones, PDAs, game machines, music recording and reproducing devices, moving picture recording and reproducing devices, large-sized computers, network electric appliances for family use, terminals to be mounted on a car, and the like.

### Embodiment 2

The second embodiment will be described. This embodiment is implemented by expanding the services of the first embodiment which is implemented on the premise of the personal service to services for firms. To make the employees of the firm use the services, the firm makes an outsourcing contract with the service provider and delivers the memory cards to the employees. The mail server, the database server, the intra-firm Web server, and PCs of employees are provided by using the server PC system.

Referring to FIG. 8, description will be given of the processing of the service provider, the firm, and the employees.

The service provider maintains and manages the server PC system (6630). The firm makes an outsourcing contract with the service provider and pays the contract fee (6605), and purchases a plurality of memory cards from the service provider (6000). The firm delivers the memory cards to the employees (6610). Each employee uses the service by use of the memory card (6620). The server PC system provides the service to the employee (6625). It is possible according to the outsourcing contract to restrict the selection of the target service for each employee. According to the restriction of the target service selection, it is also possible that at assignment of a server PC to the user, the managing server refers to the user identifier such that a server PC with a low specification is assigned to a predetermined user, the application program is not available for a predetermined user, or a virus check is forcibly conducted for a predetermined user.

Next, referring to FIG. 9, description will be given of a service providing flow of the service provider.

The service provider writes the license information in the IC card chip of the memory card and the program in the flash memory thereof (5500). The service provider makes an outsourcing contract with the user firm desiring the use of the service and registers the license information of the contents according to the contract to the managing server and then delivers the memory cards to the users (5510). Registration of a target service is accepted (5520). The target service may be freely selected by the employee or the selection items of the target service may be beforehand restricted according to the outsourcing contract. In this regard, it is also possible to set the same service to each group beforehand set (5530). When the contract expiration date reaches (5540), it is confirmed whether or not the contract is elongated (5550); if the contract is not elongated, the personal environmental data and the like are transferred to the user firm (5560) and the personal environmental data and the like are deleted (5570), and then the service contract is terminated (5580).

Next, referring to FIG. 10, description will be given in detail of the server PC system for firms. The system includes, in addition to the PCs for employees, a mail server, a database server, a Web server, and a large-sized computer.

The server PCs (1300 and 1305), the mail server 1306, the database server 1307, and the Web server 1308 are connected to an internal network 1303 of a server PC system 1241. The employee uses the server PC 1300 via the remote control program and uses the mail server 1306, the database server 1307, and the Web server 1308 on the server PC 1300. When the service provider makes the outsourcing contract with many firms, a pseudo-LAN is implemented by conducting access control of the internal network 1303 such that the pertinent firm cannot access the group of servers and the server PCs for which the contract is made with the other firms. The access control is implemented through an operation in which the managing server manages routing information of the inner network 1303 to disable the data transmission to the servers of the other firms. Also, the plural server PCs (1300 and 1305) may be replaced by one server so that a plurality of employees share the server PC in the use thereof.

As above, thanks to the providing of the outsourcing service to firms, it is not required for the firm to hold PCs and servers as its property, and the firm can trust the service provider with the management and maintenance thereof, which makes it possible to reduce the total cost for property including the purchase cost of computers and the like and the management cost. In addition, it is not required for the firm to make the contract for as many server PCs as there are employees, and it is only necessary to make the contract with the service provider side for the server PCs corresponding to the actual operation.

While description has been given of embodiments, the present invention is not restricted by the embodiments; it is recognizable to those skilled in the art that various changes and modifications are possible within the scope of the spirit of the present invention and the accompanying claims.

### BRIEF DESCRIPTION OF DRAWINGS

FIG. 1 is a configuration diagram to explain a rental PC service in a first embodiment.

FIG. 2 is a flowchart to explain the start of the use of the first embodiment.

FIG. 3 is a diagram to explain optional items for target service selection in the first embodiment.

FIG. 4 is a diagram to explain the registration data managed by the managing server in the first embodiment.

FIG. 5 is a flowchart to explain the processing flow of the service provider in the first embodiment.

FIG. 6 is a diagram to explain the card function inactivation command for the memory card of which the loss has been reported in the first embodiment.

FIG. 7 is a diagram to explain a relationship between the service provider, the shop, and the personal user in the first embodiment.

FIG. 8 is a diagram to explain a relationship between the service provider, the shop, and the personal user in the second embodiment.

FIG. 9 is a flowchart to explain the service providing operation of the service provider in the second embodiment.

FIG. 10 is a diagram to explain the server PC system for firms in the second embodiment.

FIG. 11 is a diagram to explain the mechanism to process the card function inactivation command.

FIG. 12 is a management information table of a server PC connected to the managing server.

FIG. 13 is a personal information management table managed by the managing server.

FIG. 14 is a flowchart to explain the service providing operation and the points.

FIG. 15 is a diagram to explain an example of a recommended selection combination and a restricted selection combination for each operating system.

FIG. 16 is a diagram to explain an example of the required points for each optional item.

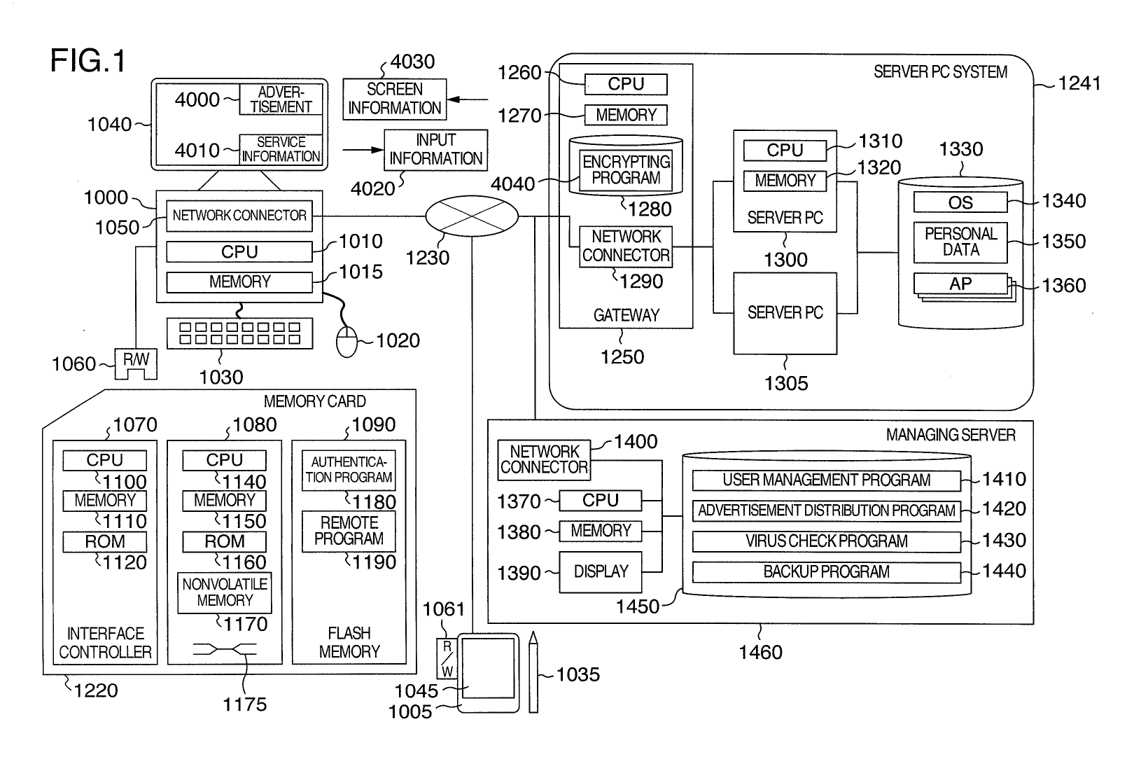

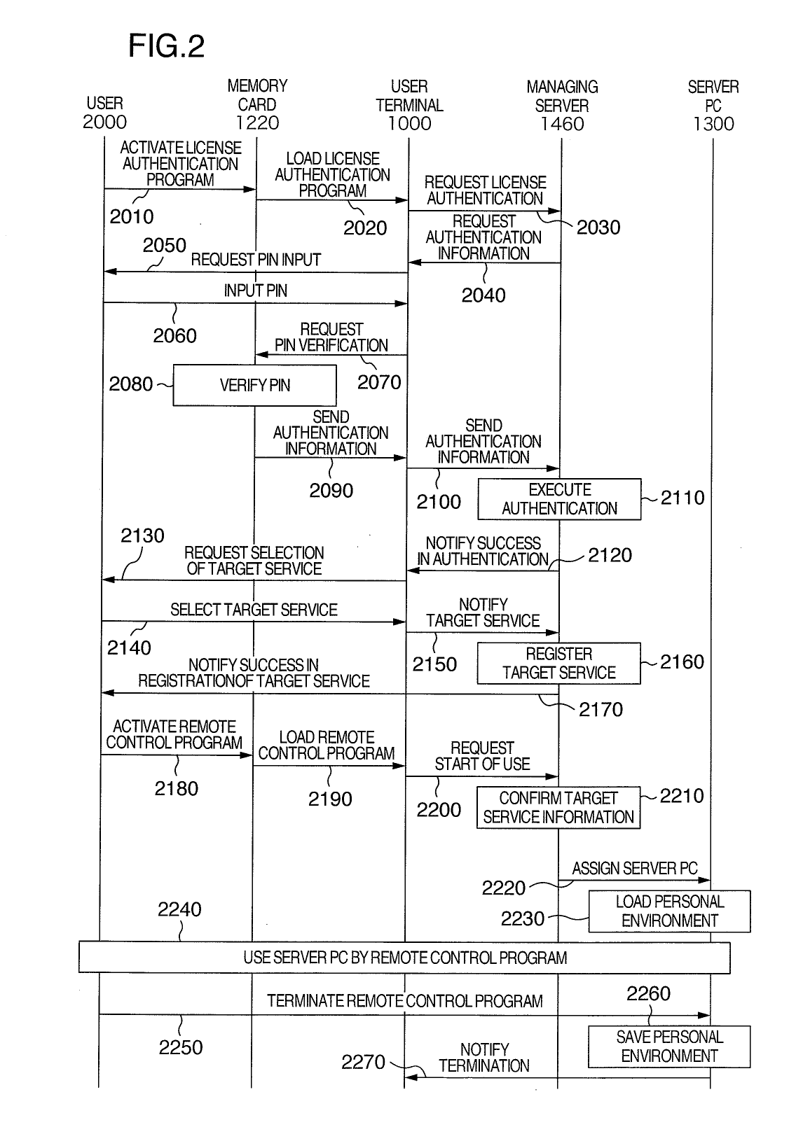

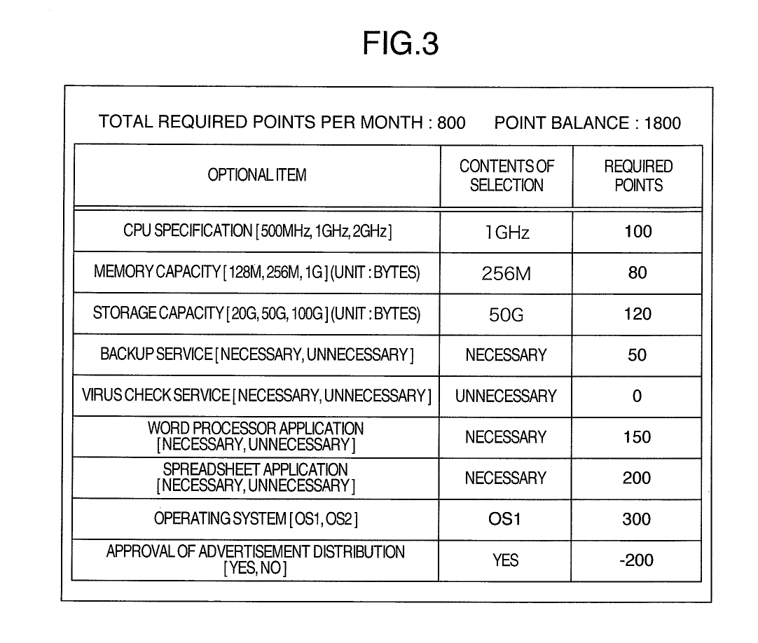

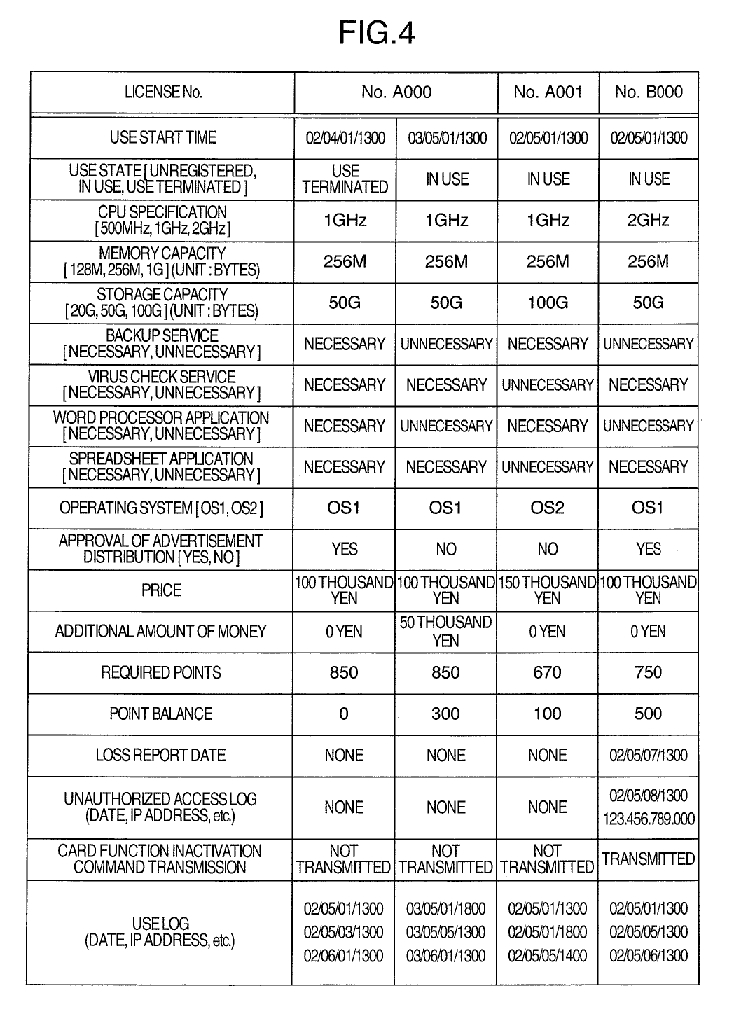

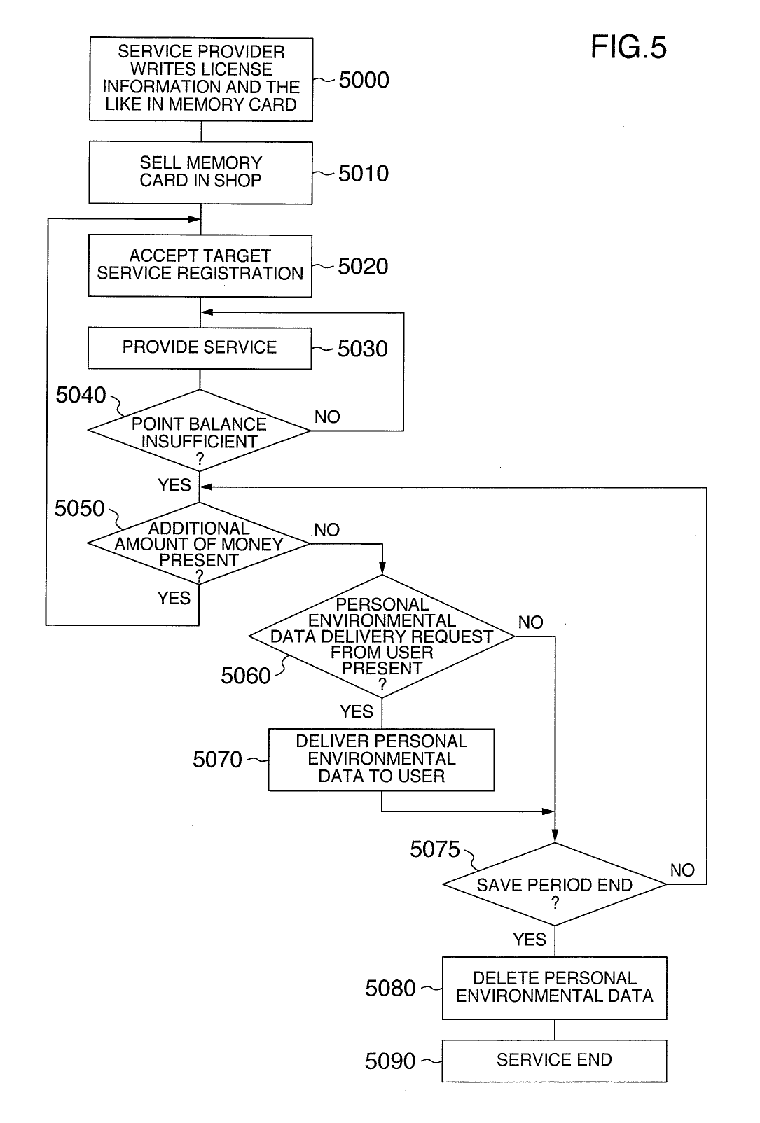

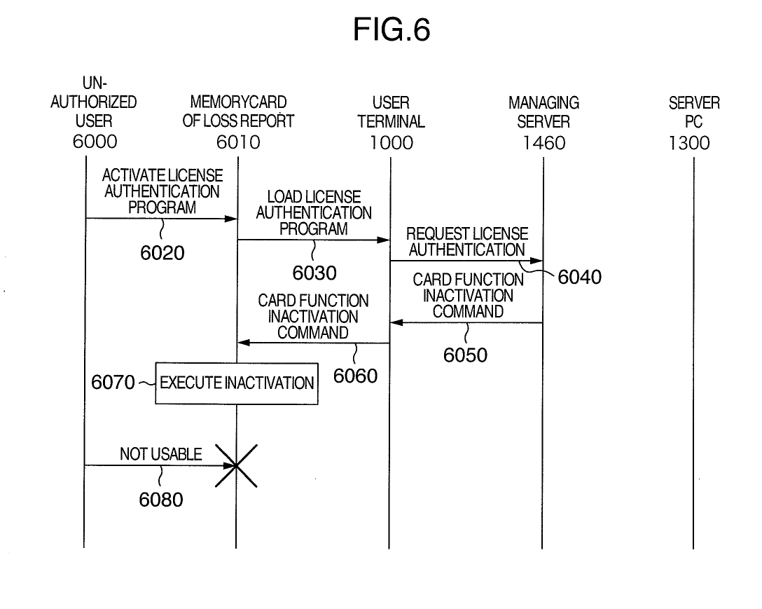

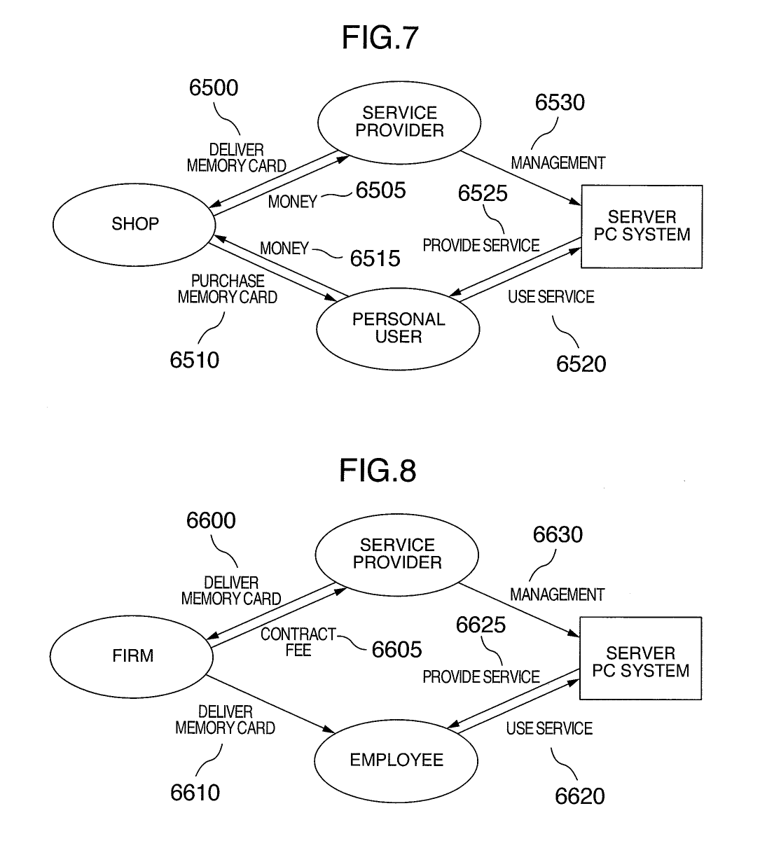

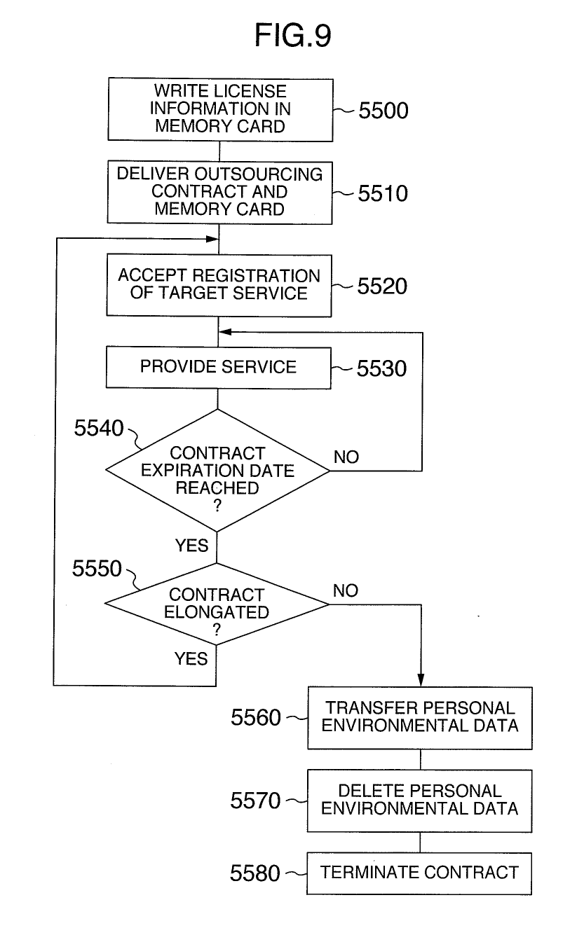

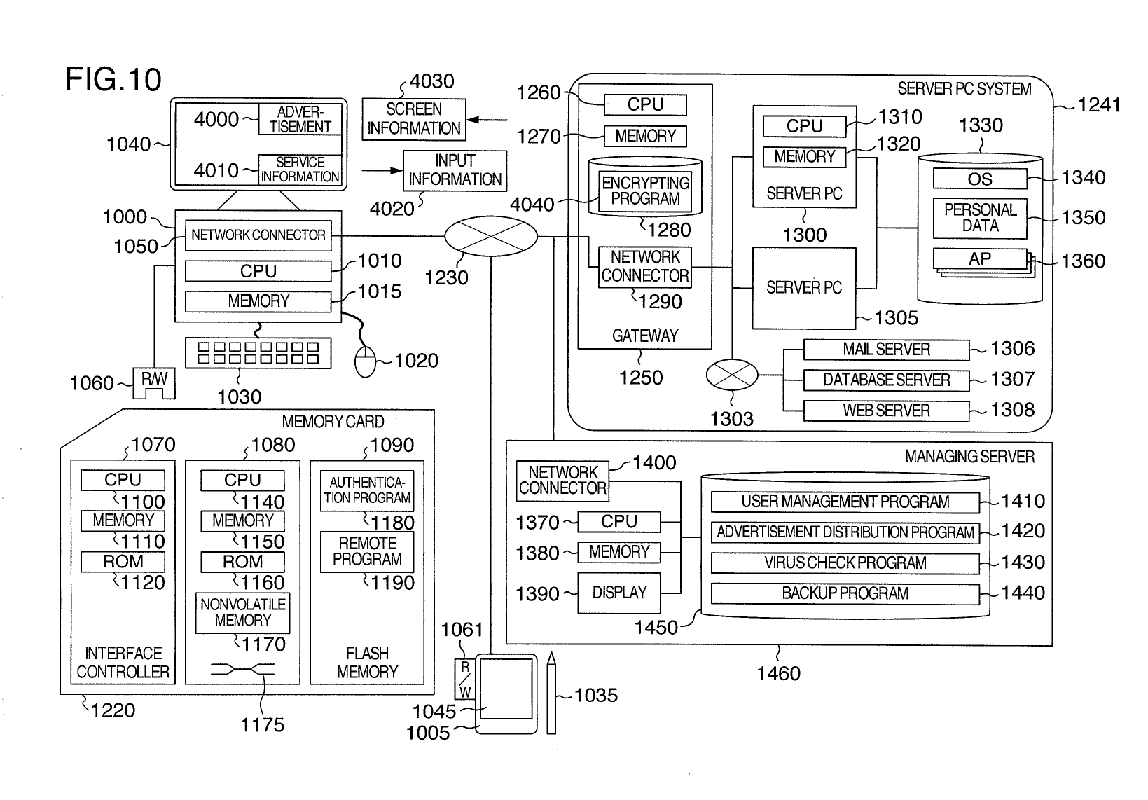

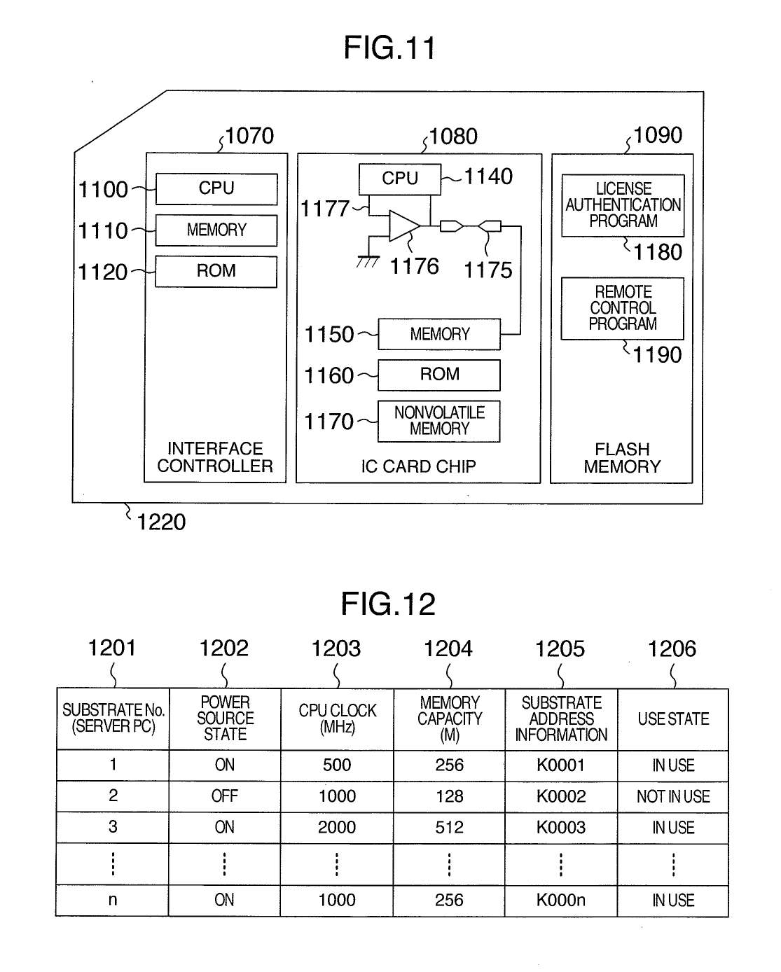

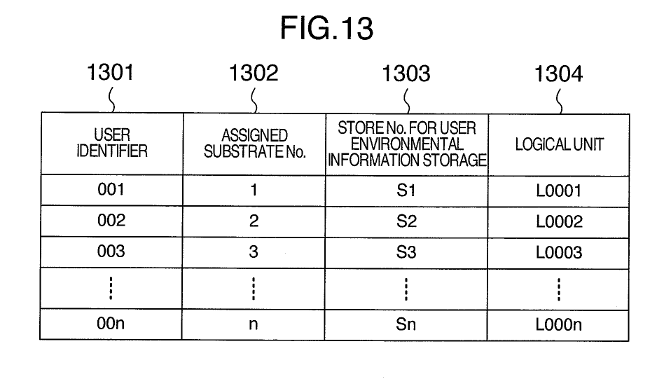

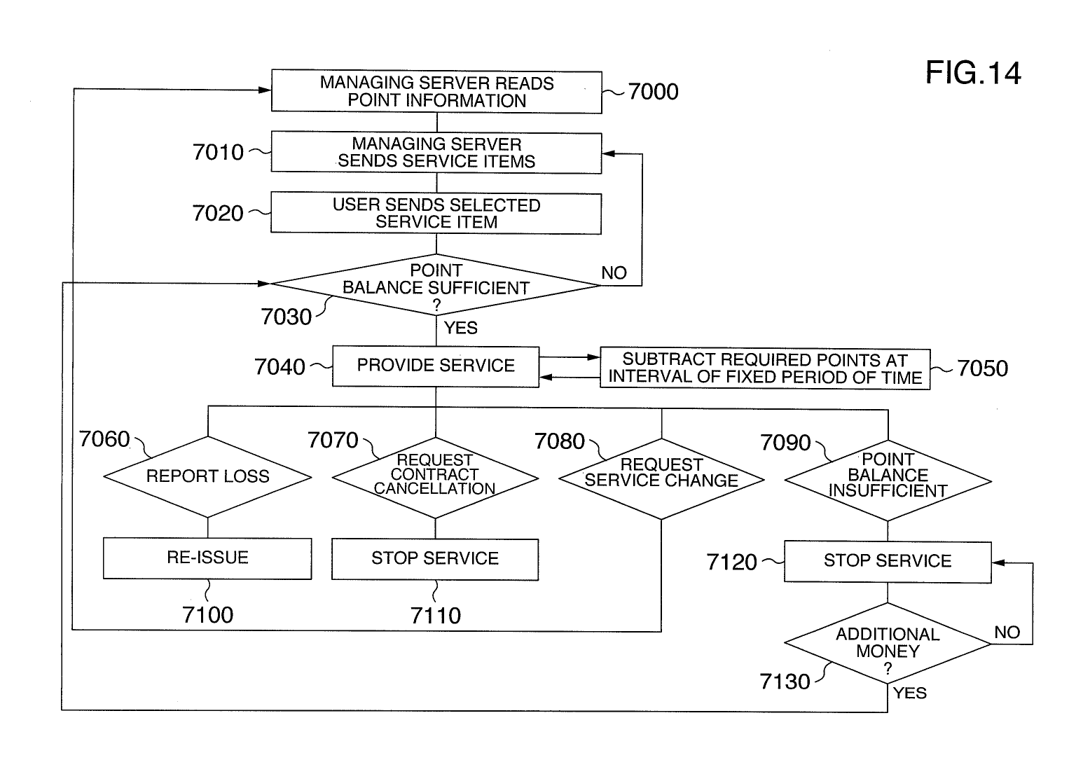

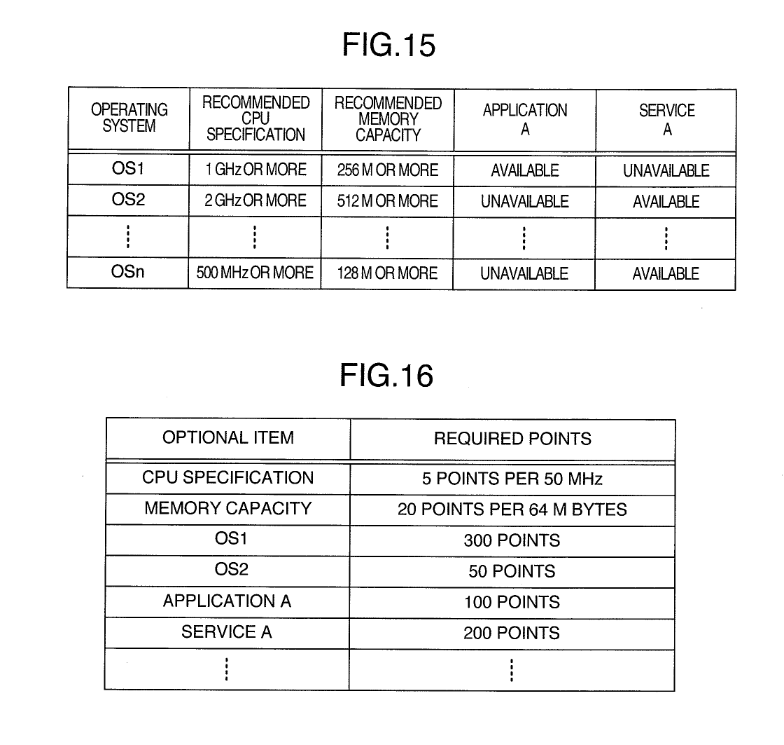

1. A computer providing system, characterized by comprising:
a server apparatus comprising a plurality of computer substrates;
a storage which is connected via a network to the server apparatus and which comprises a plurality of storage areas;
a managing server for managing the server apparatus and the storage; and
a terminal which is connected via a network to the managing server and to which a storage medium having stored user information is connected, wherein:
the managing server comprises a first table managing performance or a state of availability of each of the computer substrates and a second table prescribing a fee required to use a target service of the computer substrate or application software for a predetermined period of time;
refers to the first table, when a request for use of the computer substrate or application software is received from the terminal, and notifies available computer substrates or application software to the terminal;
refers to the second table to calculate a predetermined period of use time of a computer substrate or application software selected by the terminal, compares the calculated value with an allowed capacity of service use of the user beforehand stored in association with the user information, and assumes that the terminal may access the computer substrate or application software thus selected if the allowed capacity of service use is more than the calculated value, and then registers the use state to a third table.

2. The computer providing system according to claim 1, characterized in that the performance of the computer substrate includes a driving frequency of a CPU and a memory capacity.

3. The computer providing system according to claim 1, characterized in that the allowed capacity of service use of the user is sent from the storage medium via the terminal to the managing server together with the request for use.

4. The computer providing system according to claim 3, characterized in that
the managing server receives the user information together with the request for use, assigns a storage area corresponding to the user information according to the allowed capacity of service use, and stores in a fourth table a relationship of the storage area thus assigned, the storage area corresponding to the user information.

5. The computer providing system according to claim 4, characterized in that
the storage area thus assigned has stored personal information of a user.

6. The computer providing system according to claim 5, characterized in that
the managing server selects an unused computer substrate from a plurality of computer substrates having performance equivalent to that of the computer substrate selected by the user and then makes the computer substrate accessible.

7. The computer providing system according to claim 6, characterized in that
the managing server refers to the fourth table, when the storage medium accesses the server apparatus via the terminal; and then loads the personal information of the user in the computer substrate thus made accessible.

8. The computer providing system according to claim 1, characterized in that
the managing server registers, when the terminal sends an unauthorized access monitor request together with the user information, the monitor request to the third table with a relationship established between the monitor request and the user information;
compares the user information with second user information contained in a request for use transmitted thereafter and transmits a monitor inactivation command to the storage medium if the user information matches the second user information.

9. A computer providing system according to claim 8, characterized in that
the storage medium makes an excess current flow according to the monitor inactivation command to thereby disconnect inner wiring thereof.

10. The computer managing method for use with a computer system comprising a server apparatus comprising a plurality of computer substrates, a storage which is connected via a network to the server apparatus and which comprises a plurality of storage areas, a managing server for managing the server apparatus and the storage, and a terminal connected via a network to the managing server, characterized in that:
the managing server comprises a first table managing performance or a state of availability of each of the computer substrates and a second table prescribing a fee required to use a target service of the computer substrate or application software for a predetermined period of time;
refers to the first table, when a request for use of the computer substrate or application software is received from the terminal, and notifies available computer substrates or application software to the terminal;
refers to the second table to calculate a predetermined period of use time of a computer substrate or application software selected by the terminal, compares the calculated value with an allowed capacity of service use of the user beforehand stored in association with the user information, and assumes that the terminal may access the computer substrate thus selected if the allowed capacity of service use is more than the calculated value, and then registers the use state to a third table.

11. The computer providing method according to claim 10, characterized in that the performance of the computer substrate includes a driving frequency of a CPU and a memory capacity.

12. The computer providing method according to claim 11, characterized in that the allowed capacity of service use of the user is sent from the storage medium via the terminal to the managing server together with the request for use.

13. The computer providing method according to claim 12, characterized in that
the managing server receives the user information together with the request for use, assigns a storage area corresponding to the user information according to the allowed capacity of service use, and stores in a fourth table a relationship of the storage area thus assigned, the storage area corresponding to the user information.

14. The computer providing method according to claim 13, characterized in that
the storage area thus assigned has stored personal information of a user.

15. The computer providing method according to claim 14, characterized in that
the managing server selects an unused computer substrate from a plurality of computer substrates having performance equivalent to that of the computer substrate selected by the user and then makes the computer substrate accessible.

16. The computer providing method according to claim 15, characterized in that
the managing server refers to the fourth table, when the storage medium accesses the server apparatus via the terminal; and then loads the personal information of the user in the computer substrate thus made accessible.

17. The computer providing method according to claim 10, characterized in that
the managing server registers, when the terminal sends an unauthorized access monitor request together with the user information, the monitor request to the third table with a relationship established between the monitor request and the user information;
compares the user information with second user information contained in a request for use transmitted thereafter and transmits a monitor inactivation command to the storage medium if the user information matches the second user information.

18. The computer providing method according to claim 17, characterized in that
the storage medium makes an excess current flow according to the monitor inactivation command to thereby disconnect inner wiring thereof.

19. A method of providing, via a network from a service providing system comprising a plurality of server PCs and a managing server managing the plural server PCs, a function of a PC to a user terminal housing therein a detachable and attachable storage medium, wherein the managing server:
authenticates, in response to access from the user terminal to the service providing system, a user of the user terminal according to user information stored in the storage medium housed in the user terminal;
presents specifications of a plurality of kinds of PCs and fees for use thereof to the user terminal;
assigns to the user terminal a server PC corresponding to a specification of a PC selected by the user terminal; and
collects from the user of the user terminal the use fee corresponding to the specification of the server PC assigned to the user terminal and allows the user terminal to conduct via the network a remote operation of the server PC thus assigned, for a predetermined period of time.
